(19) United States
(12) Patent Application Publication
(10) Pub. No.: US 2025/0382001 A1
(43) Pub. Date: Dec. 18, 2025

(54) QUICK-CONNECT GRAVITY ASSISTED ADAPTER SYSTEM

(71) Applicant: Raytheon Company, Waltham, MA (US)

(72) Inventors: Eleanor MCCARTHY, Frederick, MD (US); Andrew M. GRAY, Marlborough, MA (US); Wayne M. CHOQUETTE, Rochdale, MA (US)

(73) Assignee: Raytheon Company, Waltham, MA (US)

(21) Appl. No.: 18/746,882

(22) Filed: Jun. 18, 2024

(51) Int. Cl. B62B 5/00

(52) U.S. Cl. CPC B62B 5/0089

(57) ABSTRACT

A quick-connect gravity assisted adapter system is described. A quick connect plate and receiver can be shaped and oriented to allow for quick coupling and decoupling of a lower support and moveable carriage to each other. The weight of the moveable carriage can rest on the connection surfaces between the plate and receiver and can provide for snug coupling with few or no fasteners used to make or maintain the connection between the lower support and the moveable carriage.

### GOVERNMENT RIGHTS

This invention was made with government support under a Government contract awarded by United States Government Agency. The government has certain rights in the invention.

### FIELD OF THE INVENTION

The present invention relates to a quick-connect flanged adapter system. More specifically, methods, devices, systems and articles of manufacture employing a quick-connect flanged adapter system with receiver employing self-seating gravity assisted characteristics are provided herein.

### BACKGROUND

Lower supports, such as legs or wheels, are often attached to moveable carriages. These lower supports have been attached with bolts, lock washers, and nuts requiring torque wrenches and other tools to secure the lower support to the moveable carriage with the nut, lock washer, bolt combination. These nut, lock washer, bolt combinations are time consuming to attach and remove from the moveable carriage each time the lower support is attached to the moveable carriage. Therefore, when a lower support is attached to a moveable carriage the risk of improper tightening of the nuts exists. This improper tightening can be under torquing as well over torquing the nut bolt combination.

The lower supports may be jockey wheels with height adjustment capabilities and the moveable carriages may be various assemblies including: platforms, work platforms, scaffolding, aircraft, stage systems, dollies, and other assemblies needing legs and, perhaps, temporary mobility. These and other systems are problematic to the extent that connection of the lower supports to the moveable carriage is time consuming and requires torque measurement.

A need may be appreciated for robust, quick-connecting, and lower profile interfaces, for lower support connector systems. These lower support connector systems may provide for one or more of these characteristics by employing the teachings herein.

### SUMMARY

Embodiments may comprise methods for attaching a jockey wheel or other lower support to a moveable carriage or other structure such as platforms, work platforms, scaffolding, aircraft, stage systems, dollies, and other assemblies needing legs and, perhaps, temporary mobility or permanent mobility, where the method may comprise providing a quick-connect plate; providing a jockey wheel; coupling the jockey wheel to the quick-connect plate; sliding the quick connect plate into a receiving groove, the receiving groove located on the moveable carriage, the receiving groove having an upper internal surface; and seating an edge of the quick-connect plate against the upper internal surface, wherein after seating, a weight of the moveable carriage applies a downward force from the upper internal surface onto the edge of the quick-connect plate when the jockey wheel is coupled to the quick-connect-plate and when the jockey wheel is supporting weight of the moveable carriage.

In some embodiments, the receiving groove may have an upper internal surface and two side internal surfaces. In some embodiments, the upper internal surface and the two side internal surfaces may be positioned in a receiving track, the receiving track may have a U-shape. Some embodiments may comprise inserting a quick-connect pin into at least the quick connect plate or the moveable carriage and may also employ an edge of the quick-connect plate having a chamfer.

In some embodiments, the quick-connect plate may comprise metal and in some embodiments, the quick-connect plate may be configured to adapt a mechanical connection between the jockey wheel or other lower support and the moveable carriage or other structure. In some embodiments the quick-connect pin may be mechanically connected to the receiving groove and may penetrate through a receiving track, through the quick-connect plate and into the moveable carriage when the quick-connect pin is in a secure (i.e., closed) position.

Embodiments may comprise a jockey wheel or other lower support and moveable carriage or other structure with connecting plate system. In some embodiments a jockey wheel may comprise a wheel and a metallic jockey wheel connection interface; a quick-connect plate, the plate comprising an outer edge; and a moveable carriage with a receiving track, the receiving track having a groove, the groove sized and shaped to removably receive the outer edge of the quick-connect plate, the outer edge positioned within the groove of the receiving track.

In some embodiments, a weight of the moveable carriage may apply a downward force from an upper internal surface of the groove of the receiving track, onto an edge of the quick-connect plate when the outer edge is positioned within the groove of the receiving track, and when the jockey wheel is supporting weight of the moveable carriage. In some embodiments, the jockey wheel may have a height adjustment crank; the quick-connect plate may be secured with fasteners to the metallic jock wheel connection interface; and/or the fasteners may comprise bolts and nuts and washers.

Still further, in some embodiments, a groove of the receiving track may have orthogonal sides and/or the track may comprise a u-shape; the quick-connect plate may have a rectangular side and/or a chamfered edge. In some embodiments the metallic jockey wheel connection interface may be mechanically coupled to a shaft of the jockey wheel and/or the connection interface may be positioned on a lower half of the shaft of the jockey wheel.

Embodiments may comprise a jockey wheel or other lower support and a moveable carriage or other structure such as platforms, work platforms, scaffolding, aircraft, stage systems, dollies, and other assemblies needing legs and, perhaps, temporary mobility or permanent mobility, receiving the lower support. Such systems may comprise a jockey wheel comprising a wheel, a jack, a connecting shaft positioned between the jack and the wheel, and a jockey wheel connection interface, the jockey wheel connection interface extending outward from the connecting shaft; a quick-connect plate connected to the jockey wheel connection interface, the quick-connect plate comprising an outer edge; and a moveable carriage with a receiving track, the receiving track having a groove, the groove sized and shaped to removably receive the outer edge of the quick-connect plate, the outer edge positioned within the groove of the receiving track, wherein a weight of the moveable carriage applies a downward force from an upper internal surface of the groove of the receiving track, onto an edge of the quick-connect plate when the outer edge is positioned within the groove of the receiving track, and when the jockey wheel is supporting weight of the moveable carriage.

Some embodiments may comprise a jockey wheel connection interface having a plurality of fastener passages, the fastener passages aligning with fastener passages of the quick-connect plate. Some embodiments may comprise a quick-connect plate that may be rectangular and a receiving track having a U-shape. In some embodiments, the jockey wheel connection interface may extend outward from a connecting shaft and may be rotatably connected to the connecting shaft. In some embodiments, a retractable securement slide may be employed with the slide, when in a locked orientation, positioned in a connection interface, a moveable carriage and a quick-connect plate. In some embodiments, an outer edge of the quick-connect plate may mimic a perimeter shape of a receiving track.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining within the scope of the disclosed embodiments.

### BRIEF DESCRIPTION OF THE DRAWINGS

Implementations of the inventive concepts disclosed herein may be better understood when consideration is given to the following detailed description thereof. Such description makes reference to the included drawings, which are not necessarily to scale, and which some features may be exaggerated and some features may be omitted or may be represented schematically in the interest of clarity. Like reference numerals in the drawings may represent and refer to the same or similar element, feature, or function. In the drawings:

FIG. 1 depicts a perspective view of a lower support jockey wheel with quick connect plate as may be employed in some embodiments.

FIG. 2 depicts a perspective view of a receiver with receiving track and receiving groove sized for a quick connect plate as may be employed in some embodiments.

FIG. 3 depicts a perspective view of the receiver of FIG. 2 prior to seating with the quick connect plate of FIG. 1 as may be employed in some embodiments.

FIG. 4 depicts a side sectional view of a seated quick connect plate, which is coupled to a jockey wheel lower support, seated in the receiver of FIG. 2 with a closed quick connect pin as may be employed in some embodiments.

FIG. 5 depicts a partial sectional view of the quick connect pin of FIG. 4 as may be employed in some embodiments.

FIG. 6 depicts a perspective view of an exemplary moveable carriage with four lower support jockey wheels connected via receiver and quick connect plate as may be employed in some embodiments.

FIG. 7 provides processes that may be employed in some embodiments.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of the embodiments of the inventive concepts, numerous specific details are set forth in order to provide a more thorough understanding of the inventive concepts. It will be apparent to one skilled in the art, however, having the benefit of the instant disclosure that the inventive concepts disclosed herein may be practiced without these specific details.

As used herein, a letter following a reference numeral is intended to reference an embodiment of the feature or element that may be similar, but not necessarily identical, to a previously described element or feature bearing the same reference numeral, such as 1, 1a, or 1b. Such shorthand notations are used for purposes of convenience only, and should not be construed to limit the inventive concepts disclosed herein in any way unless expressly stated to the contrary.

Moreover, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes plural unless it is obvious that it is meant otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

As used herein, any reference to “one embodiment,” “alternative embodiments,” or “some embodiments” means that particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features that may not necessarily be expressly described or inherently present in the instant disclosure.

The inventive concepts may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions. Inventive concepts may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed below.

Quick-connect gravity assisted adapter systems may be embodied in various ways. These include those taught herein as well as combinations of features understood from these teachings. Some embodiments may employ lower supports such as legs, wheels, skids, etc. that are coupled to a moveable carriage such as platforms, work platforms, scaffolding, aircraft, stage systems, dollies, and other assemblies needing legs and, perhaps, temporary mobility or permanent mobility, and employ quick connect features with gravity assist seating configurations. These gravity assist seating configurations may employ seating surfaces that meet with each other and provide for a secure connection by employing the weight of the moveable carriage resting on the lower support via, for example, the mated surfaces of quick connect plates and receivers of embodiments. These mated surfaces may be associated with the removable lower support and the moveable carriage and may be aligned with each other via a track, passage, or other guide system. The guide system may assist in initial alignment between the lower support and the moveable carriage as well as provide for a tight fit in a final seated position where little to no movement exists between the lower support and the moveable carriage when the guide system is installed and finally seated. A quick connect pin or other system may be employed for acknowledgement that a final or suitable seating position has been reached between the quick connect features of the lower support and the moveable carriage.

Embodiments may employ gravity assisted wheel interfaces with chamfer flanges for smooth installation. Some embodiments may employ a quick disconnect pin to allow user to slide a wheel interface or other lower support interface into a locking position. Lower supports may employ an integrated jack or jockey wheel where a jack may allow for multiple rolling heights, as well as lift capability of a coupled moveable carriage. Multiple interfaces may be used in conjunction in order to move larger pieces of equipment. And extended bottom flanges may be employed in some embodiments to allow for alignment and/or installation even with limited visibility.

Embodiments may be configured with lower supports, such as mechanical jacks, for performance in extreme low temperatures as well as in sand/dust or salt/fog environments. Embodiments may employ wheel interfaces (e.g., cylinder, plate, and shaft) that allow for rotation and locking at various degree increments, including ninety degrees, to allow optimal installation locations and to be rotated out of the way when not in use.

Embodiments may employ low profile interfaces of a quick connect and receiver where the combined thickness has a low profile (combined thickness) to allow for attachments in tight movement areas. And embodiments may employ internal mounting surfaces that enable a jockey wheel or other lower support to held by gravity not a pin, for increased lifting capability per wheel or other lower support. In other words, when seated, the weight of the moveable carriage may be transferred to a larger area of the quick connect and transferred down through that larger area of the quick connect rather than only though an alignment pin providing securement between the moveable carriage and the quick connect.

Embodiments may provide for simple installation with few if any tools and few if any external hardware to make connections between the lower support and the moveable carriage. Some Embodiments may not employ any nuts or bolt for the quick connect portion of the system. In other words, few if any bolts or nuts may be employed to hold an exemplary quick connect plate in a receiving groove of embodiments. Rather, the tightness of the fit along with self-seating tapers of the mating pieces and the downward weight of the moveable carriage may each provide for a suitable and robust quick-connect connection between the lower support and the moveable carriage.

Some embodiments may employ two interface plates with a bracket and a plate that mate on a chamfered surface to lock the one plate into a position that may be secure and cannot wiggle. A quick disconnect pin may also present to keep the quick connect locked in the receiver. Some embodiments may be employed to add a mobile function to a previously immobile carriage. Some embodiments may be considered a quick interface or attachment that requires no additional structural reinforcement to a carriage. Some connection systems of embodiments may be light weight but robust and capable of high weight carrying capacity.

Installation times may be short for some embodiments, in some instances taking a matter of tens of seconds for installation or removal. Gravity assisted means that in its final attached state the weight of the device in which it is attached, is aiding in the attachment. As noted above, the lower supports can be a jockey wheel being attached, but could be other things as well, such as a leg, skid plate, or integrated jack.

Existing connections use a horseshoe connection that is permanently attached. Attachment and disconnection of loose hardware can be employed in these situations. Comparably, in some embodiments, no such loose hardware may be employed. Gravity assist seated surfaces with immediate connect/disconnect confirmation pin of some embodiments may provide lateral support and may limit movement between mated surfaces.

Embodiments may employ flange(s) that slide into a groove(s) where the flange may be chamfered to assist in insertion and/or seating. Locking bolt(s) or pins at a top may be employed to hold a connected flange in place in a receiver and assist in reducing any wiggling. Some embodiments may have portions of the quick connect system removed to save weight, e.g., material of the plate or receiver may be removed.

In some embodiments, once a connection plate is attached a jockey wheel or other lower support may still be rotatable, e.g., to a retracted position or a working position, if the lower support has those features. Jockey wheel connection interfaces, or other lower support interfaces, may be a one-time installation that can be installed once to the lower support, thereby leaving the quick connect feature of embodiments still being present to connect and disconnect the lower support to the moveable carriage. In other words, some embodiments may serve as a universal adapter that can be used to connect previously incompatible parts where a quick connect plate or other component is attached to a first component and a receiver is attached to a second component and the compatibility for connecting the first component with the second component lies with the compatibility of the shapes or features of the attached quick connect plate and receiver.

Some embodiments may comprise aluminum, steel, or titanium construction with other metals and materials as well. And, low profile as used herein, means an inch or so of width when looked at through the side.

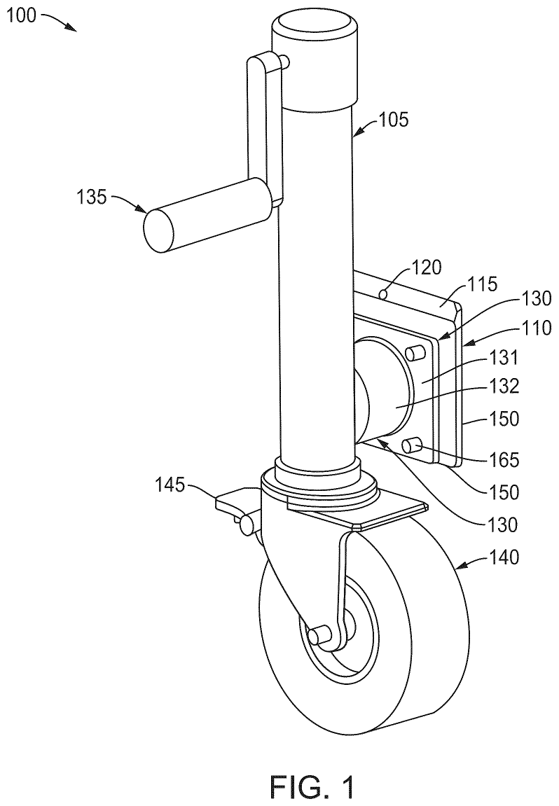

FIG. 1 depicts a perspective view of a lower support jockey wheel with quick connect plate as may be employed in some embodiments. Jockey wheel 100, jockey wheel hand crank 135, wheel lock 145, plate 131, cylinder 132, jockey wheel shaft 105, quick connect pin passage 120, chamfered edge 115, quick connect plate 110, quick connect plate outer edge 150, fastener 165, jockey wheel connection interface 130 and wheel 140 are each labelled in FIG. 1. As is shown in FIG. 1, a quick connect plate 110 may be fastened via fasteners 165 to a jockey wheel connection interface 130 or other interface for a lower support. This connection between the quick connect plate 110 and the jockey wheel interface 130 may be done once and may serve as a adapter such that a jockey wheel or other lower support may be connected to a moveable carriage or other structure via the receiver described herein. In use, the quick connect plate may be slide into a receiver groove of a receiver that is attached to a moveable carriage or other structure. The quick connect plate in this and other embodiments may have various shapes and thicknesses, the plate may be oval, rectangular, circular, horshoe shaped, etc. and the receiver may have a groove or other receiving surface that mimics the shape of the connect plate to be seated within the receiver. Thus, various shapes of the receiver and connector plate may be employed in embodiments.

As is shown in FIG. 1, the chamfered edge 115 may help with alignment and/or seating with the receiver and any groove of the receiver. The jockey wheel in FIG. 1 is shown with a hand crank 135 that allows the wheel 140 to be raised and lowered. The wheel lock 145 serves to lock the rotation of the wheel 140. The cylinder 132 of the jockey wheel 100 may allow for rotation of the jockey wheel 100 and the fasteners 165 may extend through the plate 131 so as to be able to fasten and secure the jockey wheel 100 or other lower support to the quick connect plate 110.

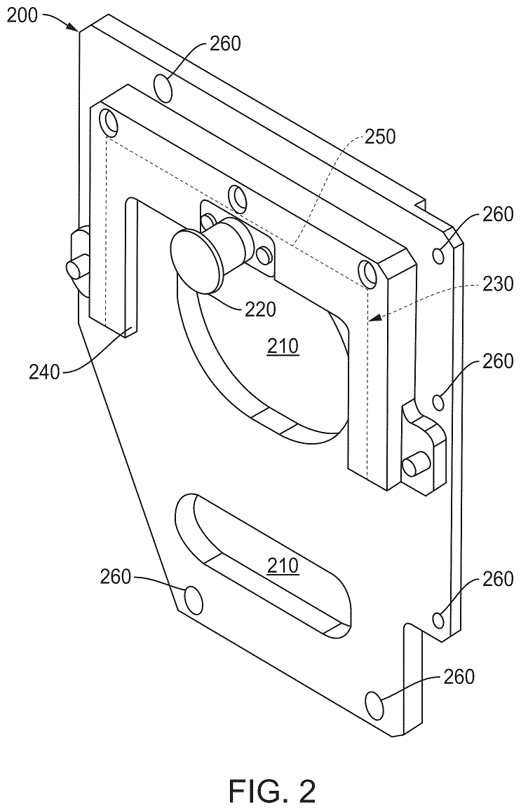

FIG. 2 depicts a perspective view of a receiver with receiving track and receiving groove sized for a quick connect plate as may be employed in some embodiments. Labelled in FIG. 2 are the receiver 200, absence of material 210, fastener passage 260, receiving groove 240, quick connect pin 220, receiving track 230, and top seat 250. The quick connect plate 110 may be sized in embodiments to slide into the receiving track 230 and become seated against the top seat 250. The quick connect pin 220 can be moved such that the quick connect plate can be slid past and then receive the pin after the pin is placed in a resting or seated position and the quick connect plats is seated in the receiving track.

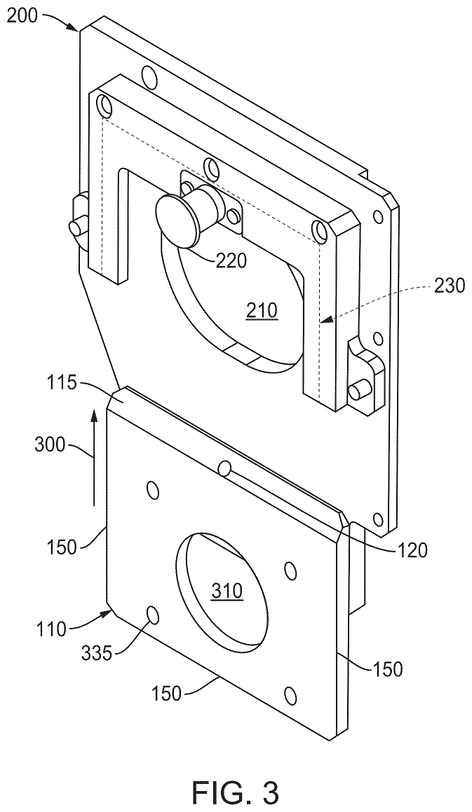

FIG. 3 depicts a perspective view of the receiver of FIG. 2 prior to seating with the quick connect plate of FIG. 1 as may be employed in some embodiments. Labelled in FIG. 3 are movement arrow 300, receiver 200, quick connect pin 220, absence of material 210, 150 quick connect plate, absence of material 310, chamfered edge 115, quick connect plate outer edge 150, quick connect plate 110, quick connect plate fastener passage 335, and quick connect pin passage 120. Movement arrow 300 shows the direction in which the, quick connect plate 110 may be moved into the receiving track 230 of the receiver 200 when connecting a jockey wheel or other lower support to a moveable carriage. Thus, the jockey wheel and the moveable carriage are not shown in FIG. 3 for ease of view.

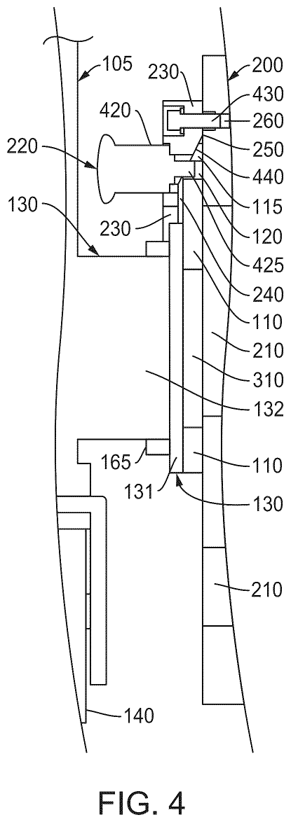

FIG. 4 depicts a side section view of a seated quick connect plate, which is coupled to a jockey wheel lower support, seated in the receiver of FIG. 2 with a closed quick connect pin as may be employed in some embodiments. Labelled in FIG. 4 are the jockey wheel shaft 105, wheel 140, cylinder 132, fastener 430, receiving track 230, receiver 200, fastener passage 260, contacted surfaces 440, chamfered edge 115, pin 425, handle 420, quick connect pin 220, receiving track 230, receiving groove 240, quick connect plate 110, absence of material 210, plate 131, fastener 165, and jockey wheel connection interface 130.

As can be seen in FIG. 4 the pin 425 can be seated in the passage 120. This seating may show that the quick connect plate 110 has been fully seated in the receiving track 230 and that the top seat 250 has been reached by the chamfered edge of the quick connect plate 110.

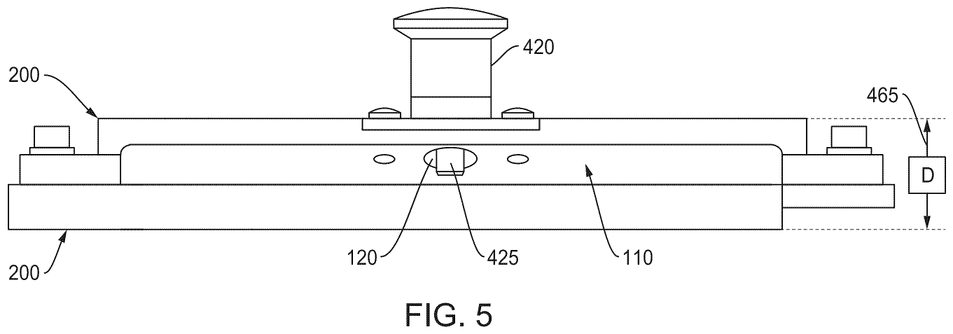

FIG. 5 depicts a partial sectional view of the quick connect pin of FIG. 4 as may be employed in some embodiments. The height or thickness of the combined quick connect plate 110 and the receiver 200 is shown as d and numeral 465. The handle 420 and pin 425 of the quick connect pin are each labelled in FIG. 5. The manner in which the pin 425 protrudes into the passage 120 of the quick connect plate 110 is visible in FIG. 5.

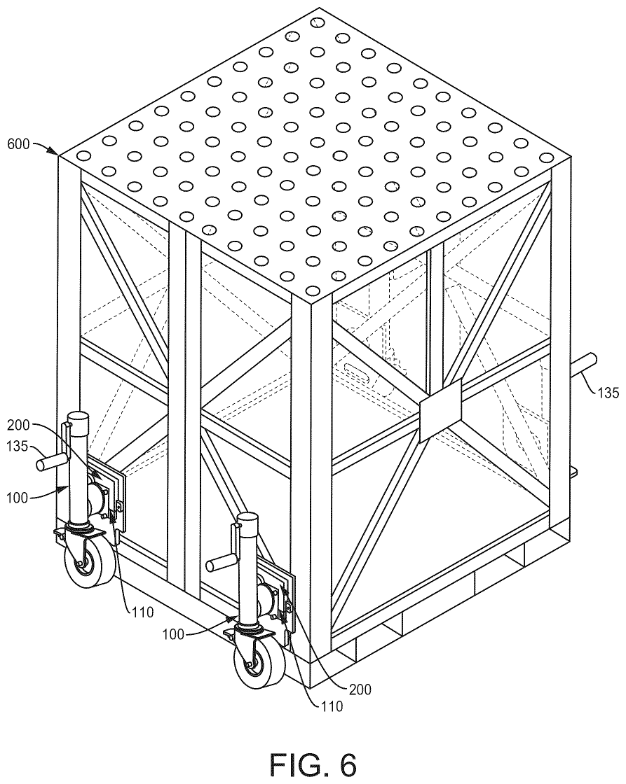

FIG. 6 depicts a perspective view of an exemplary moveable carriage 600 with four lower support jockey wheels 100 connected via receiver and quick connect plate as may be employed in some embodiments. Some of the quick connect plates 110 and the receivers 200 along with the hand cranks 135 are labelled in FIG. 6. While jockey wheels have been shown in FIG. 6, other lower supports may also be employed in embodiments. And other configurations of the moveable carriage 600 may also be employed in embodiments.

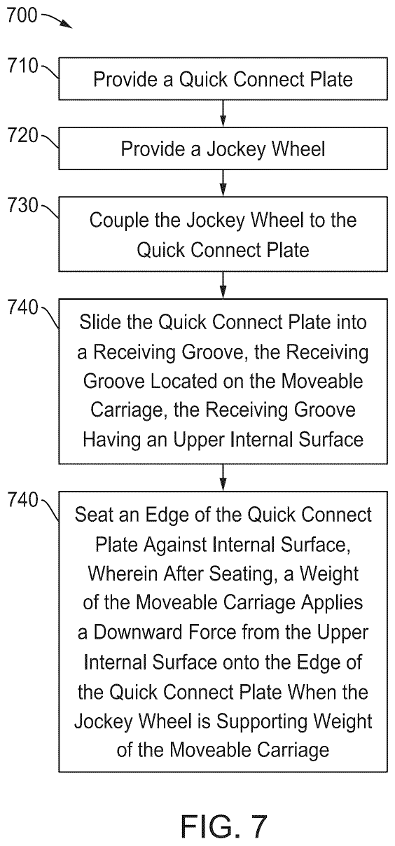

FIG. 7 provides processes that may be employed in some embodiments. Fewer, more, and different features and steps may be employed in various orders of embodiments. FIG. 7 provides at 710 providing a quick-connect plate and provides at 720, providing a jockey wheel. FIG. 7 provides at 730 coupling the jockey wheel to the quick-connect plate and provides at 740 sliding the quick connect plate into a receiving groove, the receiving groove located on the moveable carriage, the receiving groove having an upper internal surface. And FIG. 7 provides at 750, seating an edge of the quick-connect plate against the upper internal surface, wherein after seating, a weight of the moveable carriage applies a downward force from the upper internal surface onto the edge of the quick-connect plate when the jockey wheel is coupled to the quick-connect-plate and when the jockey wheel is supporting weight of the moveable carriage. Various other processes may be employed in embodiments, including processes utilizing the various features and teachings described herein. These processes may be performed in various sequences and orders and with some of the features described herein.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer-usable program code embodied in the medium.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

1. A method for attaching a jockey wheel to a moveable carriage, the method comprising:
providing a quick-connect plate;
providing a jockey wheel;
coupling the jockey wheel to the quick-connect plate;
sliding the quick connect plate into a receiving groove, the receiving groove located on the moveable carriage, the receiving groove having an upper internal surface;
seating an edge of the quick-connect plate against the upper internal surface, wherein after seating, a weight of the moveable carriage applies a downward force from the upper internal surface onto the edge of the quick-connect plate when the jockey wheel is coupled to the quick-connect-plate and when the jockey wheel is supporting weight of the moveable carriage.

2. The method of claim 1 wherein the receiving groove has the upper internal surface and two side internal surfaces.

3. The method of claim 2 wherein the upper internal surface and the two side internal surfaces are positioned in a receiving track, the receiving track having a U-shape.

4. The method of claim 1 further comprising inserting a quick-connect pin into at least the quick connect plate or the moveable carriage.

5. The method of claim 1 wherein the edge of the quick-connect plate has a chamfer.

6. The method of claim 1 wherein the quick-connect plate comprises metal.

7. The method of claim 1 wherein the quick-connect plate is configured to adapt a mechanical connection between the jockey wheel and the moveable carriage.

8. The method of claim 4 wherein the quick-connect pin is mechanically connected to the receiving groove and penetrates through a receiving track, through the quick-connect plate and into the moveable carriage when the quick-connect pin is in a secure position.

9. A jockey wheel and moveable carriage with connecting plate system, the system comprising:
a jockey wheel comprising a wheel and a metallic jockey wheel connection interface;
a quick-connect plate, the plate comprising an outer edge; and
a moveable carriage with a receiving track, the receiving track having a groove, the groove sized and shaped to removably receive the outer edge of the quick-connect plate, the outer edge positioned within the groove of the receiving track,
wherein a weight of the moveable carriage applies a downward force from an upper internal surface of the groove of the receiving track, onto an edge of the quick-connect plate when the outer edge is positioned within the groove of the receiving track, and when the jockey wheel is supporting weight of the moveable carriage.

10. The system of claim 9 wherein the jockey wheel has a height adjustment crank.

11. The system of claim 9 wherein the quick-connect plate is secured with fasteners to the metallic jock wheel connection interface.

12. The system of claim 11 wherein the fasteners comprise bolts and nuts and washers.

13. The system of claim 11 wherein the groove of the receiving track has orthogonal sides and wherein the track comprises a u-shape, and the quick-connect plate has a rectangular side and a chamfered edge.

14. The system of claim 11 wherein the metallic jockey wheel connection interface is mechanically coupled to a shaft of the jockey wheel and the connection interface is positioned on a lower half of the shaft of the jockey wheel.

15. A jockey wheel and moveable carriage with connecting plate system, the system comprising:
a jockey wheel comprising a wheel, a jack, a connecting shaft positioned between the jack and the wheel, and a jockey wheel connection interface, the jockey wheel connection interface extending outward from the connecting shaft;
a quick-connect plate connected to the jockey wheel connection interface, the quick-connect plate comprising an outer edge; and
a moveable carriage with a receiving track, the receiving track having a groove, the groove sized and shaped to removably receive the outer edge of the quick-connect plate, the outer edge positioned within the groove of the receiving track,
wherein a weight of the moveable carriage applies a downward force from an upper internal surface of the groove of the receiving track, onto an edge of the quick-connect plate when the outer edge is positioned within the groove of the receiving track, and when the jockey wheel is supporting weight of the moveable carriage.

16. The system of claim 15 wherein the jockey wheel connection interface has a plurality of fastener passages, the fastener passages aligning with fastener passages of the quick-connect plate.

17. The system of claim 15 wherein the quick-connect plate is rectangular and the receiving track is U-shaped.

18. The system of claim 15 wherein the jockey wheel connection interface extends outward from the connecting shaft and is rotatably connected to the connecting shaft.

19. The system of claim 15 further comprising a retractable securement slide, the slide, when in a locked orientation, positioned in the connection interface, the moveable carriage and the quick-connect plate.

20. The system of claim 15 wherein the outer edge of the quick-connect plate mimics a perimeter shape of the receiving track.
